(19) United States
(12) Patent Application Publication
(10) Pub. No.: US 2011/0307114 A1
(43) Pub. Date: Dec. 15, 2011

(54) SUBSTATION AUTOMATION DEVICE AND SYSTEM

(75) Inventors: Steven A. Kunsman, Apex, NC (US); Jean-Charles Tournier, Bellegarde sur Valserine (FR); Thomas Werner, Baden (CH)

(73) Assignee: ABB RESEARCH LTD, Zurich (CH)

(21) Appl. No.: 13/173,838

(22) Filed: Jun. 30, 2011

Related U.S. Application Data
(63) Continuation of application No. PCT/EP2009/067712, filed on Dec. 22, 2009.

(30) Foreign Application Priority Data
Jan. 7, 2009 (EP) 09150130.4

(51) Int. Cl. G06F 1/28; G06F 1/26

(52) U.S. Cl. 700/292; 700/297

(57) ABSTRACT

Exemplary embodiments provide separate SA system-level functionalities or tasks, which are conventionally performed by a multitude of distinct station-level devices, through a single SA device having a plurality of Processing Units (PU). The latter are either distinct Central Processing Units (CPUs) mounted on the same processor board, or distinct processing cores of a single multi-core CPU sharing the same Random Access Memory (RAM). Virtualization techniques are used in supporting multiple instances of Operating Systems (OS) on the plurality of PUs, to create distinct and mutually isolated execution environments are created. Each of these execution environments hosts a single functionality out of a Supervisory Control And Data Acquisition (SCADA) functionality, a gateway functionality, an engineering workplace functionality, and a firewall functionality.

### RELATED APPLICATION

This application claims priority under 35 U.S.C. §119 to European Patent Application No. 09150130.4 filed in Europe on Jan. 7, 2009, the entire content of which is hereby incorporated by reference in its entirety.

### FIELD

The disclosure relates to the field of substations, such as, Substation Automation for substations of high or medium voltage power transmission networks.

### BACKGROUND INFORMATION

Substations in high and medium-voltage power networks can include primary devices such as electrical cables, lines, bus bars, switches, power transformers and instrument transformers, which are generally arranged in switch yards and/or bays. These primary devices are operated in an automated way via a Substation Automation (SA) system. The SA system comprises secondary devices, among which Intelligent Electronic Devices (IED) are responsible for protection, control and monitoring of the primary devices. The secondary devices can be assigned to hierarchical levels, i.e. the station level, the bay level, and the process level, the latter being separated from the bay level by a so-called process interface.

IEDs on the station level of the SA system share, at least to a certain extent, the same configuration and/or information about the substation, and can include:

i) a station PC or supervisory computer on which a Supervisory Control And Data Acquisition (SCADA) software is executed, and including an Operator Work Station (OWS) with a local Human-Machine Interface (HMI) for displaying the status of primary equipment (switch position, current/voltages);

ii) a gateway for communication with a Network Control Centre (NCC) or other stations, and for converting protocol information;

iii) an engineering PC that includes an Operator Work Station for modifying or updating the configuration of the station PC, specifically of the HMI and SCADA systems; and

iv) a firewall—separating the station bus from other networks, such as corporate network.

The above enumerated station-level tasks, processes or functions can be either running on dedicated devices (gateways, firewalls), or on Industrial PCs (Local HMI, Engineering PC). The station level IEDs can be connected to a station bus conventionally serving the purpose of exchanging commands and status information among IEDs on the station level and the bay units or protection and/or control IEDs on the bay level. Finally, secondary devices on the process-level include sensors for voltage (VT), current (CT) and gas density measurements, contact probes for sensing switch and transformer tap changer positions, and/or actuators (I/O) for changing transformer tap positions, or for controlling switchgear like circuit breakers or disconnectors.

A communication standard for communication between the secondary devices of a substation has been introduced by the International Electrotechnical Committee (IEC) as part of the standard IEC 61850 entitled “communication networks and systems in substations”. For non-time critical messages, IEC 61850-8-1 specifies the Manufacturing Message Specification (MMS, ISO/IEC 9506) protocol based on a reduced Open Systems Interconnection (OSI) protocol stack built upon the Transmission Control Protocol (TCP) and Internet Protocol (IP) in the transport and network layer, respectively, and upon Ethernet and/or RS-232C as physical media. For time-critical event-based messages, IEC 61850-8-1 specifies the Generic Object Oriented Substation Events (GOOSE) directly on the Ethernet link layer of the communication stack. For very fast periodically changing signals at the process level such as measured analogue voltages or currents IEC 61850-9-2 specifies the Sampled Value (SV) service, which like GOOSE builds directly on the Ethernet link layer. Hence, the standard defines a format to publish, as multicast messages on an industrial Ethernet, event-based messages and digitized measurement data from current or voltage sensors on the process level as a substitute to traditional copper wiring.

Using the above standards, SV or other process data can be transmitted over an inter-bay process bus, making the transmitted information available to neighbouring bays. For cost effective setups such as in medium or low-voltage substations, the inter-bay process bus and the station bus can be merged into one single communication network. Assuming that information which is used in executing protection and control functionality is shared through a bus, emerging “digital substation” concepts open up new centralized Protection & Control possibilities. For instance, PC-like devices on a station level would not only serve as a gateway or HMI console, but would also host backup functionality for the bay IED devices, or execute station-wide protection schemes such as busbar protection.

U.S. Pat. No. 6,550,020 discloses a data processing system with at least one Integrated Circuit IC containing a central processing unit that includes at least first and second processing cores. Each of the processing cores includes a full set of the components utilized by conventional single-core CPU to fetch, decode, and execute instructions and transfer information to and from other parts of the data processing system such as a global data storage or shared memory. The IC also includes input facilities that receive control input specifying which of the processing cores is to be utilized, e.g. to utilize the second core as a virtual first processing core upon determining that the first core is inactive or defective. To this end, the IC includes configuration logic that dynamically decodes the control input and, in response, selectively controls reception of input signals and transmission of output signals of one or more core of the processing cores in accordance with the control input.

In advanced computer technology, a virtualization layer provided between the physical hardware of a computing system and one or more guest operating systems running on that hardware supports distinct execution environments, or Virtual Machines VM, to which the guest operating systems are assigned. The guest systems can be independent from each other, i.e. they do not know about the existence of the other guest systems. As a result, the virtualization layer virtualizes, or partitions, all physically available hardware resources specified by the guest systems, e.g. CPU, memory storage devices, I/O devices such as network cards or adapters, printers, displays. A single guest operating system runs or executes on each virtual machine, and one or more applications in turn run on the guest operating system and behave as if they were running on their own dedicated real computer.

U.S. Pat. No. 7,299,468 discloses an automatic resource management for a virtual machine operating system that includes a multiplicity of virtual machines that are allocated a finite amount of resources, such as private virtual memory, real CPU and real I/O. The patent addresses time- or application dependent needs for each of the allocated resources. For example, during some periods, the virtual machine can be executing applications requiring complex arithmetic computations which are CPU intensive and during other periods the virtual machine can be executing applications such as data backup applications which hardly use the CPU. Hence, if the one virtual machine needs additional resources, the one virtual machine is automatically cloned. The clone is allocated a share of the resources taken from the shares of other of the virtual machines, such that the resultant shares allocated to the one virtual machine and the clone together are greater than the share allocated to the one virtual machine before the one virtual machine was cloned.

### SUMMARY

An exemplary embodiment of the present disclosure is directed to Substation Automation (SA) device connected to a station bus of a substation of an electric power transmission or distribution system including multiple Processing Units (PU) on a single board as main processing hardware on which a first and a second execution environment is created by means of virtualization techniques, wherein a first and a second functionality of a set of system-level substation functionalities, which includes Supervisory Control And Data Acquisition (SCADA), gateway, engineering and firewall functionalities, is assigned to the first and to the second execution environment, respectively.

### BRIEF DESCRIPTION OF THE DRAWINGS

The subject matter of the invention will be explained in more detail in the following text with reference to preferred exemplary embodiments which are illustrated in the attached drawings, in which:

FIG. 1 illustrates a substation in accordance with the prior art;

FIG. 2 illustrates an architecture of an SA device with multiple processing units in accordance with an exemplary embodiment; and

FIG. 3 illustrates a portion of a substation with an SA device in accordance with an exemplary embodiment.

The reference symbols used in the drawings, and their meanings, are listed in summary form in the list of reference symbols. In principle, identical parts are provided with the same reference symbols in the figures.

### DETAILED DESCRIPTION

It is an objective of an exemplary embodiment of the present disclosure to simplify a structure of a Substation Automation (SA) system, to reduce the number of independent SA devices, and to save overall system costs related to hardware, engineering, and maintenance.

In an exemplary embodiment of the present disclosure, separate SA system-level functionalities or tasks, which are conventionally performed by a multitude of distinct station-level devices, can be provided by a single SA device that includes a plurality of Processing Units (PU) on a single circuit board as main processing hardware. By means of virtualization techniques supporting multiple instances of Operating Systems (OS) on the plurality of PUs, distinct and mutually isolated execution environments can be created. Each of these execution environments can host a single functionality out of a Supervisory Control And Data Acquisition (SCADA) functionality, a gateway functionality, an engineering workplace functionality and a firewall functionality.

The plurality of PUs can be either a plurality of distinct Central Processing Units (CPUs), or physical chips, mounted on the same circuit board, or a plurality of processing cores of a single multi-core CPU sharing the same Random Access Memory (RAM), or a combination thereof.

The SA device includes shared hardware resources or components, in particular volatile memory such as RAM, Input/Output (I/O) devices such as Hard Disk Drives HDD, communication interfaces to connect to printers and displays, and network interfaces to connect to an SA station bus. Virtualization techniques prevent, despite of the shared resources, mutual influence between the execution environments thus supporting the merging of the abovementioned station-level functions. Each execution environment, also called Virtual Machine (VM), runs a guest OS that in turn may support Symmetric Multi-Processing (SMP), i.e. the guest OS can handle several of the processing cores.

In another exemplary embodiment, each execution environment can run the very same guest OS as the dedicated station-level device which conventionally performed the single functionality that is being merged to the SA device. For example, the SCADA runs under “Windows embedded”, the gateway functionality under “VxWorks”, and the engineering tasks under “Windows”. No modifications or adaptations to the original application set-up are required prior to performing the merged functionality by the SA device.

In an exemplary embodiment of the present disclosure, even protection and/or control functionality, either for centralized, station-wide schemes or on behalf of an individual substation bay, is also hosted by one of the execution environments. This set-up achieves backup functionality on behalf of dedicated protection & control Intelligent Electronic Devices (IEDs), or bay units, without adding hardware; the only prerequisite being that measurements and control commands are available to the SA device via the station/process bus. Substation configuration information can in this case advantageously be shared between the different protection and control applications. Protection and control functionality can be executed within one or several dedicated execution environments, as one process on one core, as two separate processes; or with every protection function allocated to a dedicated core. The latter corresponds to a level of granularity in the allocation, or isolation, of processes or functions to separate processing cores without precedent.

In another exemplary embodiment, the SA device can adapted to be used in SA systems with separate communication networks for process and station bus applications. This can be realized given the fact that SCADA, Engineering and the gateway applications are directly allocated to the corresponding Station Bus Network Interface Card (NIC), whereas the protection and control functions additionally utilize the process bus NIC in order to receive and send messages from and to the process bus.

In an exemplary embodiment of the present disclosure, various levels of redundancy can be achieved by duplication, or even triplication of, the entire SA device including all shared resources, or of critical system components. The latter includes at least the power supply and storage, duplication of which can increase reliability on a SA device level. On the other hand, from an overall station perspective, the SA device itself can be installed in a redundant setup, assuming proper redundancy or switchover mechanisms such as hot-standby (OWS, gateway, control) or hot-hot (protection) between the redundant SA devices. Alternatively, reliability can be increased by means of software redundancy, with each of the functionalities being instantiated several times on the same SA device in separate execution environments, or by combined hardware and software redundancy. In addition, functionalities with no redundancy nowadays, such as a Human Machine Interface (HMI), can be doubled at no additional cost.

The maturing of the IEC 61850 standard can allow for innovative architectural concepts in Substation Automation, and safe operation of substation bays can be achieved with different hardware setups. In order to counterbalance a possible decrease in reliability due to the increased number of components and devices, integration of functionality into fewer devices, but with the possibility of selective functionality or hardware redundancy, is herein proposed.

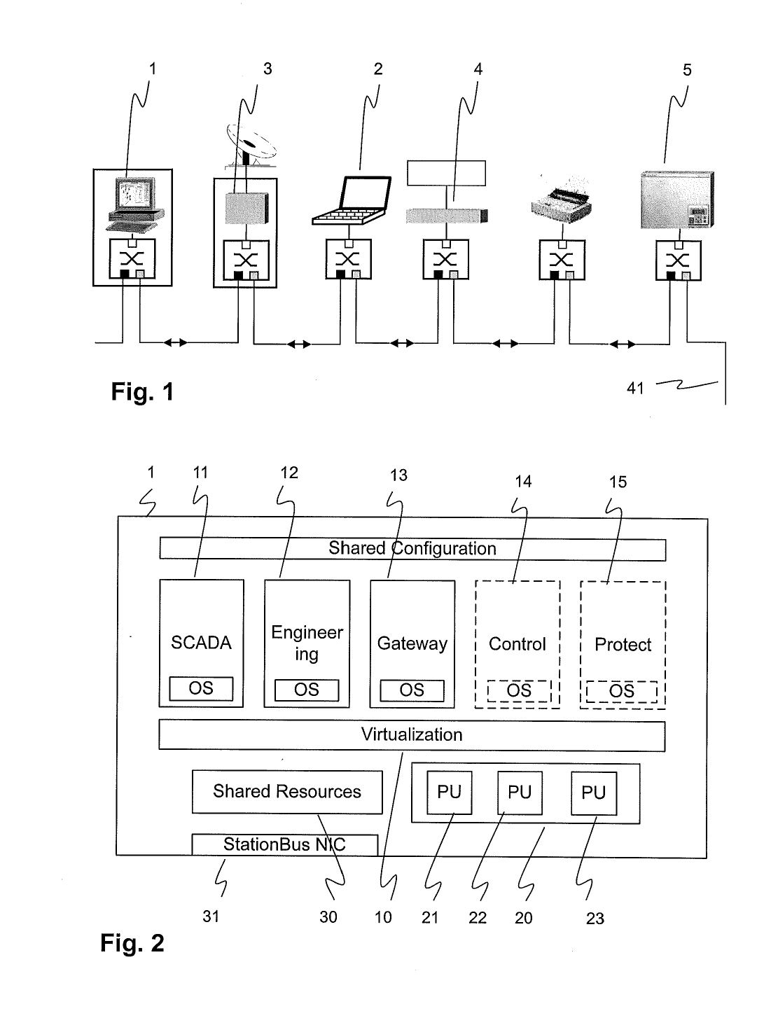

FIG. 1 illustrates a substation in accordance with the prior art. FIG. 1 shows a portion of a prior art Substation Automation (SA) setup from the perspective of a communication infrastructure with installed functionality. Each of the station-level functionalities is hosted on a separate and dedicated computing device: Supervision workstation, or Station PC, with SCADA functionality and a HMI 1, Engineering PC 2, Gateway device 3, firewall 4, and optional station computer or IED 5 for executing Protection and Control functionality. The devices are all connected, via appropriate switches, to a substation-wide station bus 41. Most of the devices are running different OS, such as Windows (HMI/Engineering), Windows embedded (Station computers), or VxWorks (gateways, IEDs).

FIG. 2 illustrates an architecture of an SA device with multiple processing units in accordance with an exemplary embodiment. FIG. 2 shows an architecture of an SA device 1 with multiple Processing Units 21, 22, 23 mounted on a single circuit board (motherboard), or even being part of a single multi-core CPU 20, some shared resources 30 such as volatile memory, Flash memory, HardDiskDrive, and a shared Network Interface card 31. The SA Device includes several execution environments or Virtual Machines 11-15, enabled and supported by a virtualization layer 10 on top of the processing hardware. The different execution environments host the functions and applications to be executed, by providing or emulating the full hardware chain of an independent PC. To that purpose, the virtualization layer controls access to the shared hardware resources (HDD, NIC) and to the Processing Units 21, 22, 23. The different execution environments run different Operating Systems (OS) which in turn execute the different station-level functionality such as SCADA 11, Engineering 12, Gateway 13, and optionally Control 14 and Protection 15 applications. When reverting to the original OS, the set-up of the functions and applications is substantially unchanged as compared to their conventional implementation on distinct devices. As such, no modifications to the software code are necessary.

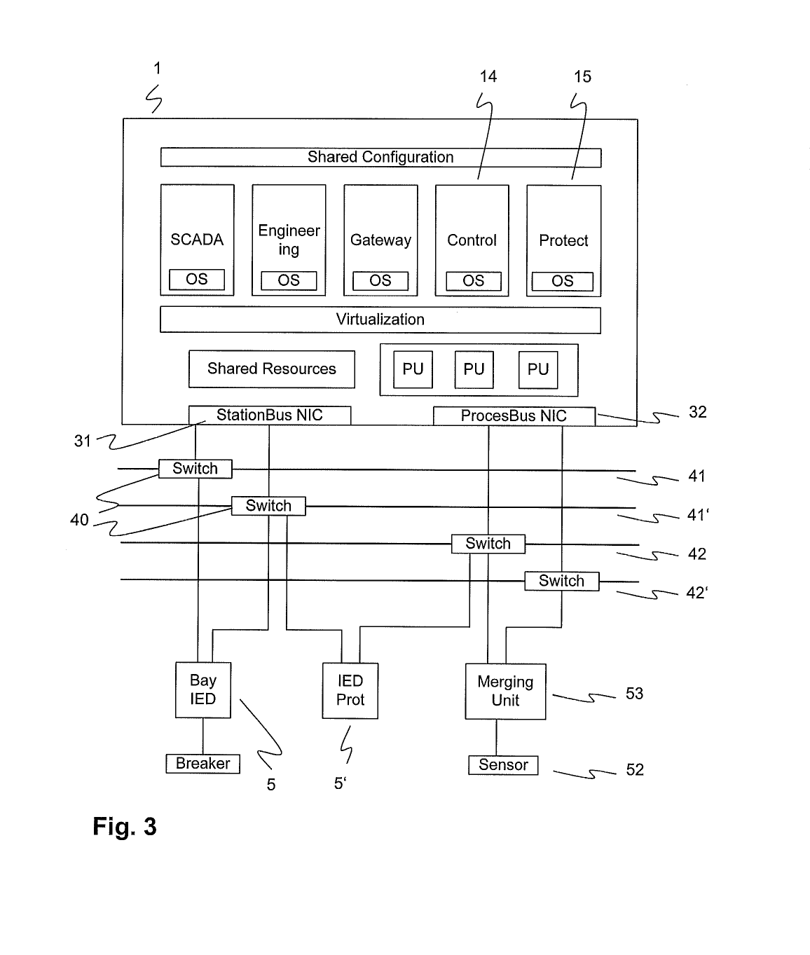

FIG. 3 illustrates a portion of a substation with an SA device in accordance with an exemplary embodiment. FIG. 3 shows an excerpt of a Substation Automation system with an SA device 1 hosting all relevant SA functionalities collapsed into a single system. The station bus network interface 31 connects via switches 40 to a redundant station bus 41, 41′ for exchanging actuator commands, alarms and events with IEDs 5, 5′ of the substation. As the SA device itself also hosts (backup) protection functionality 15, can be equipped with a process bus interface 32 which connects via switches to a redundant process bus 42, 42′. Sensors 52 such as CT/VT sensors are located in respective bays and provide their measurements or other operational data, e.g. via IED 5′ or Merging Unit 53, to the process bus 42, 42′. Other combinations of sensors connected to IED devices and/or the process bus, as well as other redundancy schemes for protection and control can be possible.

Thus, it will be appreciated by those skilled in the art that the present disclosure can be embodied in other specific forms without departing from the spirit or essential characteristics thereof. The presently disclosed embodiments are therefore considered in all respects to be illustrative and not restricted. The scope of the disclosure is indicated by the appended claims rather than the foregoing description and all changes that come within the meaning and range and equivalence thereof are intended to be embraced therein.

### LIST OF DESIGNATIONS

1 SA Device
2 Engineering PC
3 Gateway
4 Firewall
5 IED
10 virtualization layer
11-15 execution environments
20 mulit-core CPU
21, 22, 23 Processing Units
30 shared resource
31, 32 Network Interface Card
40 network switch
41 station bus
42 process bus
52 sensor
53 Merging Unit

What is claimed is:

1. A Substation Automation (SA) device connected to a station bus of a substation of an electric power transmission or distribution system comprising:
multiple Processing Units (PU) on a single board as main processing hardware on which a first and a second execution environment is created by means of virtualization techniques,
wherein a first and a second functionality of a set of system-level substation functionalities, which includes Supervisory Control And Data Acquisition (SCADA), gateway, engineering and firewall functionalities, is assigned to the first and to the second execution environment, respectively.

2. The SA device according to claim 1, wherein each of the multiple PUs is an individual Central Processing Unit (CPU), or an individual processing core of a multi-core CPU.

3. The SA device according to claim 1, wherein the distinct execution environments run different Operating Systems.

4. The SA device according to claim 1, wherein a third execution environment handles substation protection functionality.

5. The SA device according to claim 4, comprising:
two network interfaces for connecting to the station bus and a process bus.

6. The SA device according to claim 1, wherein the execution environments share hardware resources, and some of the shared resources are duplicated.

7. A Substation Automation (SA) system for operating a substation of an electric power transmission or distribution system, comprising:
a number of Intelligent Electronic Devices (IEDs) for protecting and controlling the substation, an SA device according to claim 1, and a substation-wide station bus interconnecting the IEDs and the SA device.

8. The SA system according to claim 7, comprising:
a number of sensors for measuring process values, an SA device according to claim 4, and a process bus interconnecting the sensors and the SA device.
